(19) United States
(12) Patent Application Publication
(10) Pub. No.: US 2010/0013856 A1
(43) Pub. Date: Jan. 21, 2010

(54) IMAGE PROCESSING DEVICE AND IMAGE PROCESSING CIRCUIT

(75) Inventor: Shinya Abe, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/503,202

(22) Filed: Jul. 15, 2009

(30) Foreign Application Priority Data
Jul. 18, 2008 (JP) 2008-187696

(51) Int. Cl. G09G 5/00

(52) U.S. Cl. 345/629

(57) ABSTRACT

Image data of first and second planes are created based on display image data containing first and second image data. At least a portion of the first plane corresponding to a display region of the second image data is set to have a color other than black. When the second image data is black, the first image data is set for a first region of the second plane corresponding to a display region of the first image data, and a second region of the second plane corresponding to the non-display region of the first image data is set to a transparent mode. The created image data may be blended so that an image of the image data of the second plane can be superimposed on an image of the image data of the first plane. The blended image data may be used to display an image display panel.

### CROSS REFERENCE TO RELATED APPLICATION

This application is based upon and claims the benefit of priority from the prior Japanese Patent Application No. 2008-187696, filed on Jul. 18, 2008, the entire contents of which are incorporated herein by reference.

### FIELD OF THE INVENTION

The invention relates to an image processing device and an image processing circuit to display an image on an image display panel of a self-luminous display.

### DESCRIPTION OF THE BACKGROUND

Image display devices, which are capable of displaying an image having an aspect ratio different from that of an image display panel of the image display device, have been widely used. In such image display devices, an image is displayed on a central portion of the image display panel. In addition, side regions are formed on the image display panel to surround the central portion. On the side regions (hereinafter referred to as “side panels”), image is not displayed.

SD image data (720×480 pixels, and an aspect ratio of 4:3) having standard resolution may be transmitted in digital television broadcasting for a full HD image data (1920×1080 pixels, and an aspect ratio of 16:9) having high resolution. In this case, side panels are added to both of horizontal sides of the SD image to create an image corresponding to an angular field of 16:9. Data of the created image is transmitted to a receiver. The receiver can recognize the transmitted image as a full HD image, and can display the transmitted image on an image display panel without any change.

A self-luminous display device with an image display panel, such as a plasma display device, can be used as an image display device. In such an image display device, phosphors of picture elements, which are formed in a region other than side panel regions, are deteriorated earlier than those formed in the side panel regions, when side panels are filled with black. This is because a black color does not cause the picture elements formed in the side panel regions to emit light.

Deterioration of the phosphors of the picture elements proceeds earlier in the region other than the side panel regions so that uneven brightness arises in the image display panel.

Japanese Patent Application Publication No. 2005-49750 discloses a plasma display device. In the plasma display device, picture elements formed in side panels are caused to emit light at a minimum necessary brightness so that uneven brightness may be prevented on an image display panel sufficiently.

In order to emit light at the minimum necessary brightness, the picture elements of the side panels are made to emit light at respective brightness levels modified in accordance with differences in brightness characteristic among phosphors of colors of R, G, and B, which constitute phosphor layers. The plasma display device is capable of balancing deterioration of phosphors of all the colors, while causing each picture element of the side panels to emit light at low brightness.

The patent publication does not show concrete measures to display an image of inputted display image data having side panels on an image display panel while causing the side panels to emit light.

### SUMMARY OF THE INVENTION

An aspect of the present invention provides an image processing device, which includes an image memory to receive and store display image data, a graphics engine to process the display image data stored in the image memory, the graphics engine including first and second processing sections to perform processing of creating image data of first and second planes based on the display image data and to store the created image data in the image memory, and a blend circuit to blend the stored image data of the first and second planes so that an image of the image data of the second plane can be superimposed on an image of the image data of the first plane, and to output the blended image data to display an image on an image display panel of a self-luminous display, wherein, when the display image data has data of a first image having an aspect ratio different from that of the image display panel, and has data of a second image to be displayed in a non-display region where the first image is not displayed in the image display panel, the first processing section performs processing to set a portion of the image data of the first plane to have a color other than black, the portion corresponding to at least a display region of the second image, and the second processing section performs processing to set the data of the first image for a first region of the image data of the second plane corresponding to a display region of the first image and to set data of a second region of the second plane corresponding to the non-display region of the first image to a transparent mode, when the data of the second image is black.

Another aspect of the present invention provides an image processing circuit, which includes first and second processing sections, the image processing circuit functioning as a graphics engine to process display image data and to output the processed image data, the image processing circuit creating image data of first and second planes based on the display image data, wherein, when the display image data has data of a first image having an aspect ratio different from that of an image display panel, and has data of a second image to be displayed in a non-display region where the first image is not displayed in the image display panel, the first processing section sets a portion of the image data of the first plane to have a color other than black, the portion corresponding to at least a display region of the second image, and the second processing section performs processing to set the data of the first image for a first region of the image data of the second plane corresponding to a display region of the first image and to set data of a second region of the second plane corresponding to the non-display region of the first image to a transparent mode, when the data of the second image is black.

### BRIEF DESCRIPTION OF THE DRAWINGS

FIG. 1 is a view to explain a principle of image display applied to an image processing device according to an embodiment of the invention.

FIG. 2 is a block diagram showing the image processing device according to the embodiment.

FIGS. 3A and 3B are views showing examples of images respectively displayed on an image display panel by the image processing device according to the embodiment.

FIGS. 4A to 4C are flow charts showing an example of a processing procedure of an inputted display image which is performed in the image processing device according to the embodiment.

FIG. 5A is a view showing an example of an image displayed on the image display panel of the image processing device according to the embodiment.

FIG. 5B is a view showing an image displayed on an image display panel of an image processing device according to a comparative example.

FIG. 6 is a view to explain a principle of image display applied to the image processing device according to the comparative example.

FIG. 7 is a block diagram showing an image processing device according to a modification of the embodiment.

### DETAILED DESCRIPTION OF THE INVENTION

Hereinafter, an embodiment of the invention will be described with reference to the drawings. In the drawings, the same portions are denoted by the same reference numerals respectively. An image processing device according to the embodiment displays an image on an image display panel of a self-luminous display.

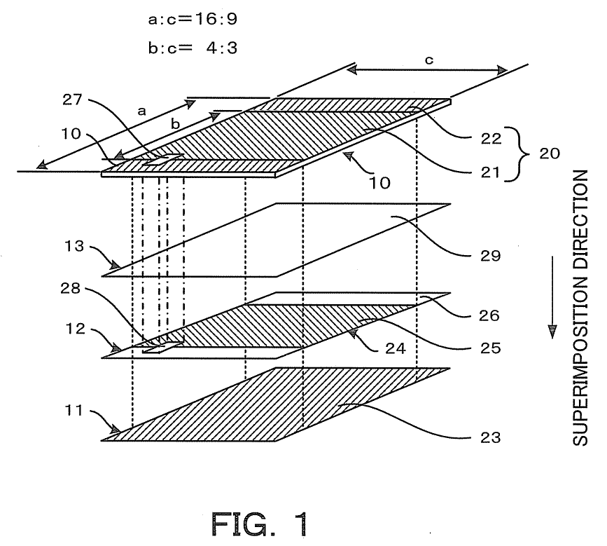

FIG. 1 is a view to explain a principle of image display applied to the image processing device according to the embodiment. In FIG. 1, image data of first to third planes 11 to 13 are respectively created based on data of an inputted display image. Composite image data is created by blending the created image data. The composite image data is obtained by processing the image data of the first to third planes 11 to 13, so that an image of the data of the third plane 13 can be superimposed on an image of the second plane 12 and so that an image of the second plane 12 can be superimposed on an image of the first plane 11. Based on the obtained composite image data, a composite image 20 is displayed on an image display panel 10 of a self-luminous display.

The composite image 20 includes a first image 21, which displays a video, and second images 22 for side panels arranged on both sides of the first image 21. In the image display panel 10, the second images 22 are displayed in regions where the first image 21 is not displayed (hereinafter called as “non-display regions”). The image display panel 10 has an aspect ratio of (a:c). The first image 21 has an aspect ratio of (b:c) which is different from the aspect ratio of (a:c).

The first plane 11 may be a plane to display a background color, and is referred to as a background (BG) plane. The second plane 12 may be a plane to display an actual video, such as a motion picture, and is referred to as a video plane. The third plane 13 may be a plane to display information on an electric program guide, data broadcasting, or the like. The third plane 13 is referred to as a main graphics (MG) plane.

The first plane 11 has a first region 23 which displays an image. The second plane 12 has a second region 24 which displays an image. The third plane 13 has a third region 29 which displays an image.

In the embodiment, the overall first region 23 of the first plane 11 is set to a color such as a gray color other than black. The first image 21 is set on a region 25 of the second plane 12, which corresponds to a region where the first image 21 is displayed (hereinafter called as “display region”). Regions 26 of the second plane 12, which corresponds to display regions of the second images 22, are set to a transparent mode. The overall third region 29 of the third plane 13 is set to a transparent mode.

A third image 27, which is displayed to overlap display and non-display regions of the first image 21, may be added to the composite image 20 displayed on the image display panel 10. The third image 27 is time information, which is character information, for example. In this case, the third image 27 is set on a third region 28 of the second plane 12, which corresponds to a display region of the third image 27 located on the image display panel 10.

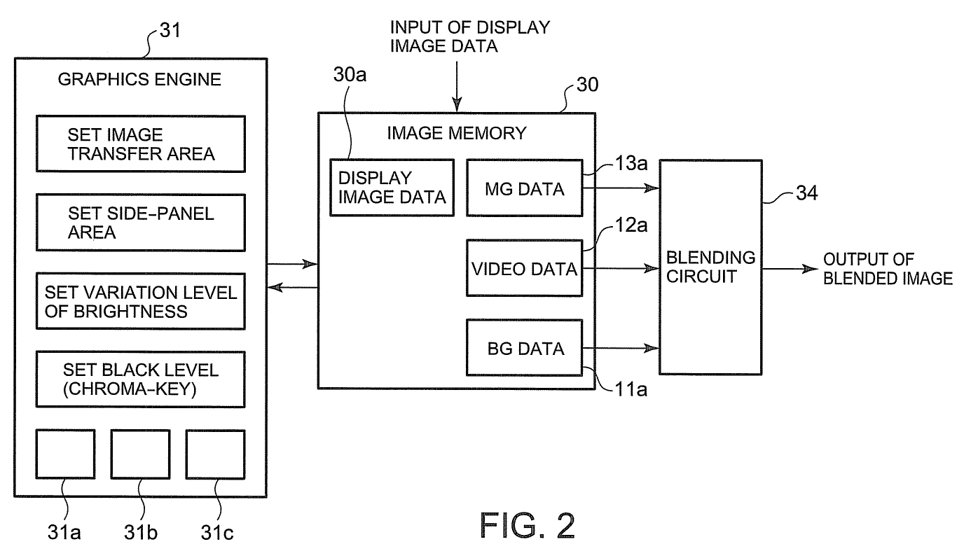

FIG. 2 is a block diagram showing a system configuration of the image processing device according to the embodiment.

As shown in FIG. 2, the image display device includes an image memory 30 as a main memory, a graphics engine 31 and a blend circuit 34.

The image memory 30 may be a DRAM. The graphics engine 31 is an LSI (image processing circuit) to perform image processing. The blend circuit 34 is an LSI to perform image synthesis.

The following initial settings are performed in the graphics engine 31. The display region of the first image 21 and the non-display regions of the first image 21, i.e., the whole image display region, are set in the graphics engine 31 as a transfer region. The non-display regions of the first image 21 are set as side panel regions. A brightness unevenness level, which is allowable in the non-display regions of the first image 21, is set in the graphics engine 31. Furthermore, a judgment condition, which is used to determine whether or not the brightness of the non-display regions of the first image 21 is in a black level, is set in the graphics engine 31.

In FIG. 2, the graphics engine 31 has processing sections 31a, 31b. The processing section 31a sets memory regions which are used to store image data respectively corresponding to the first to the third planes 11, 12, 13, in the image memory 30. The processing section 31a writes inputted display image data 30a into the image memory 30.

The processing section 31b of the graphics engine 31 performs processing the written display image data based on the initial settings.

The image data processed in the processing section 31b is written into the memory regions of the image memory 30. The memory regions store BG data 11a, Video data 12a, and MG data 13a corresponding to the first to the third planes 11, 12, 13, respectively.

The BG data 11a, the Video data 12a and MG data 13a, respectively corresponding to the first to the second planes 11 to 13, are blended by the blend circuit 34. The blend circuit 34 blends the data 11a, 12a and 13a of the first to third planes to obtain a composite image data, so that an image of the data 12a can be superimposed on an image of the data 11a, and so that an image of the data 13a can be superimposed on an image of the data 12a.

The obtained composite image data is outputted from the blend circuit 34 to an image display circuit (not shown) and is displayed on the image display panel 10 of the self-luminous display.

The third plane 13 is set to the transparent mode as described above. The color other than black, which is set on the first region 23 of the first plane 11, is transmitted through the region 26 of the second plane 12 by superposing of these three planes so that the images 22 are formed on the image display panel 10.

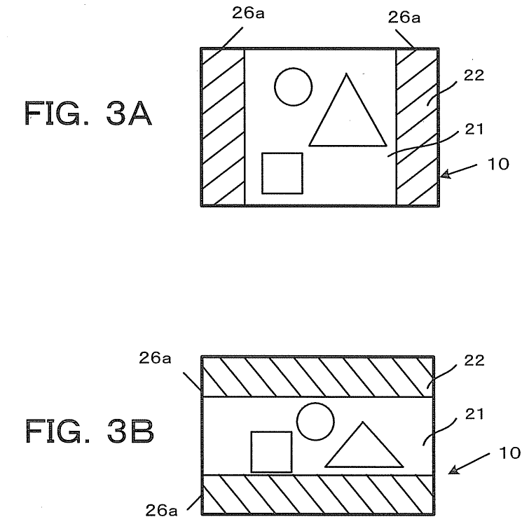

FIGS. 3A and 3B are views showing examples of an image displayed on the image display panel 10. FIG. 3A shows a case where the image display panel 10 has side panel regions 26a on the right and left sides of the image display panel 10. FIG. 3B shows a case where the image display panel 10 has side panel regions 26a on the top and bottom sides of the image display panel 10. The latter case is called as a “letterbox”.

As shown in FIGS. 3A and 3B, the second images 22 are displayed on the side panel regions 26a, which are the non-display regions of the first image 21.

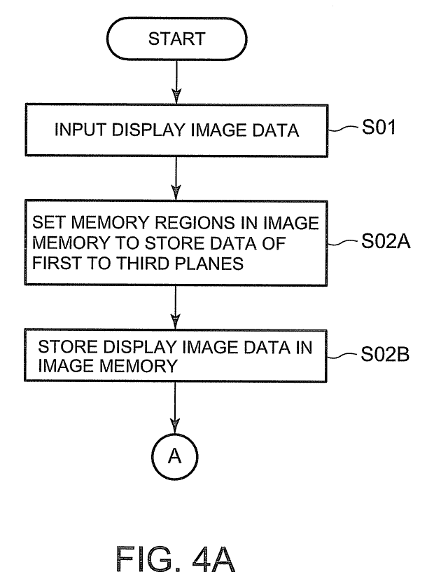

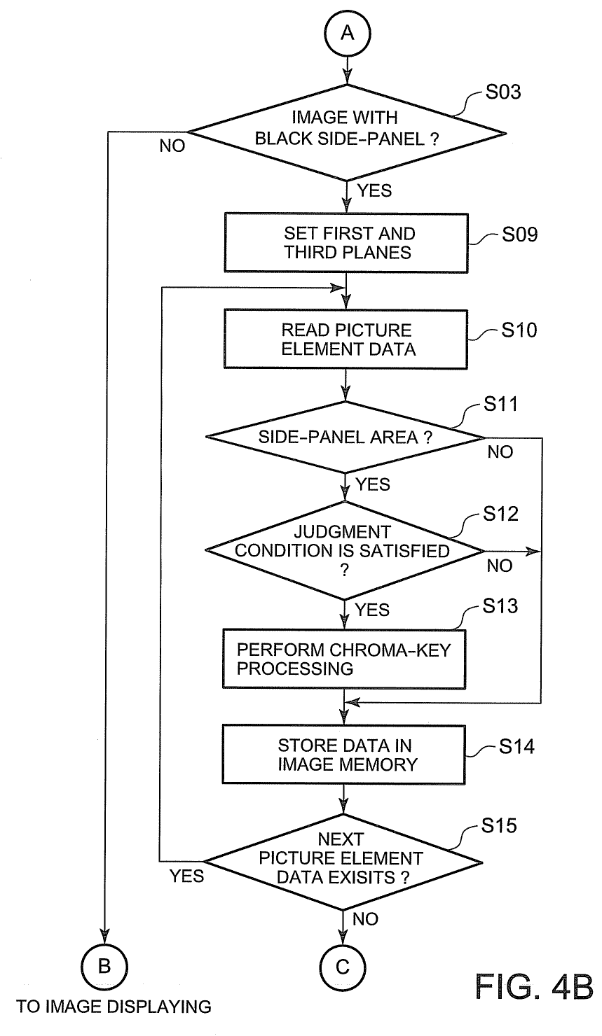

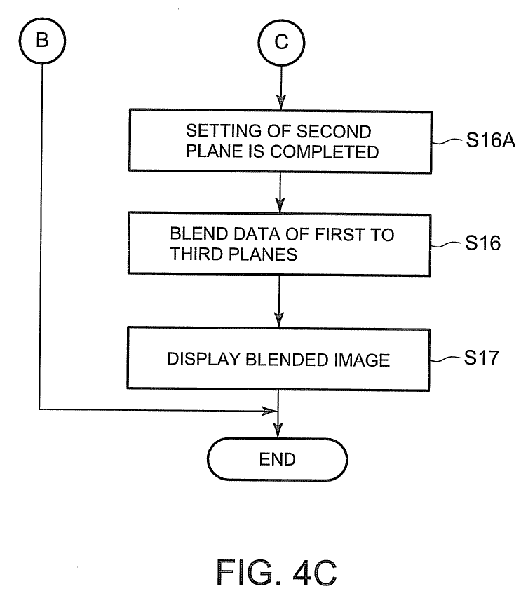

FIGS. 4A to 4C are flow charts showing an example of processing to display an image on the image display panel based on the inputted display image data. The processing is performed by the image processing circuit (graphics engine) shown in FIG. 2.

As shown in FIG. 4A, display image data to be displayed on the image display panel 10 is inputted from a digital broadcasting tuner, for example (Step S01).

Memory regions, which store image data respectively corresponding to the first to the third planes 11, 12, 13, are set in the image memory 30 (Step S02A). The processing section 31a in the graphics engine 31 performs the initial settings of the memory regions.

The processing section 31a stores inputted display image data in the image memory 30 as the image data 30a (Step S02B).

The processing section 31b of the graphics engine 31 determines whether the image data 30a has data of the first image 21 and data of the second images 22. The first image 21 has an aspect ratio of (b:c) different from the aspect ratio of (a:c) of the image display panel 10. The second images 22 are displayed on the non-display regions of the first image 21 in the image display panel 10. The graphics engine 31 determines whether the second image 22 is black, i.e., the image to be displayed on the image display panel 10 has black side panel regions (Step S03).

The above determinations are performed in the following first to third stages. In the first stage, brightness information of picture elements, which exist in the non-display regions of the first image 21, are obtained. In the second stage, a ratio of a number of picture elements, which have brightness information smaller than a first reference value, to the number of all of the picture elements, is calculated. In the third stage, it is determined whether the ratio of the number of the picture elements having the smaller brightness information is equal to or more than a second reference value.

More specifically, brightness information of each picture element in the side panel regions is read from the image memory 30. The side panel regions are determined in advance in accordance with the aspect ratio of (16:9) of the image display panel 10 and the aspect ratio of (4:3) of the first image 21. When the brightness information is expressed by 256 gradations, the first reference value, which determines the brightness information of each picture element as black, is set to 10, for example.

In this case, the number of picture elements having a gradation ranging from the first to tenth lowest gradations is counted. A ratio of the counted number of picture elements to the number of all of the picture elements is calculated. Then, whether the image to be displayed on the image display panel 10 has black side panel regions is determined, based on a determination result as to whether the calculated ratio is equal to or more than the second reference value to determine the side panel regions as black, which is 95% or more, for example.

When the third image 27, which may be character information, is added to the display image 20 to be displayed on the image display panel 10 of FIG. 1, the brightness information of picture elements of the third image 27 may be larger than the first reference value. However, since the number of picture elements to display the third image 27 is small, the third image 27 does not affect the determination of the ratio of the picture elements.

If it is determined that the image has black side panel regions at Step S03, the processing section 31b sets the picture element data of the overall first region 23 of the first plane 11 to a color such as a gray color other than black. Furthermore, the processing section 31b sets the picture element data of the overall third region 29 of the third plane 13 to a transparent mode (step S9).

After these settings are finished, a processing section 31c performs the following processing. Brightness information and color information are read into the graphics engine 31 from the image memory 30 for every picture element to display the display image data 30a (Step S10).

If it is determined that the image does not have black side panel regions at Step S03, an image formed by the display image data, which is stored in the image memory 30, is displayed on the image display panel 10 without any change.

In the graphics engine 31, it is determined whether the corresponding picture element is a picture element located in the side panel regions, based on the brightness information and color information read for every picture element (Step S11). In advance, existence of the side panel regions are judged in accordance with the aspect ratio of (16:9) of the image display panel 10 and the aspect ratio of (4:3) of the first image 21

If the picture elements, whose brightness information and color information are read, are those located in the side panel region at Step S11, it is determined whether or not a “judgment condition” expressed by the following formula (1) is satisfied (Step S12).

When brightness information of a picture element is “P”, a black level is “BL”, and a maximum width of variation in the black level is “±α”, the picture element is determined as “black” if the brightness information P of the picture element satisfies the following judgment condition. When the picture element satisfies the judgment condition, it shows that a third image 27 such as time information as character information does not exist in the image corresponding to the inputted display image data.

(BL−α)≦P≧(BL+α) (1)

If it is determined that picture elements of the side panel regions are not “black”, a third image 27 is judged as being added to the side panel regions.

If the judgment condition is satisfied at Step S12, it shows that a third image 27 is not added. Thus, chroma key processing is performed for the whole side panel regions (Step S13). The chroma key processing extracts specified color information from image data, and adds other color information to the image data. The image data obtained by the chroma key processing is stored in the image memory 30 (Step S14).

On the other hand, if it is determined at step S11 that a picture element whose brightness information and color information is read, is not a picture element located in the side panel regions, or if it is determined at Step S12 that the judgment condition is not satisfied, a chroma key processing is not performed for the image data of the picture element. The image data of the picture element is stored in the image memory 30 at Step S14 without any change. If the judgment condition is not satisfied so that image data of the picture element corresponding to the third image 27 is not black, a chroma key processing is not performed for the image data of the picture element.

Image data of each of the picture elements is sequentially stored in the memory region of the image memory 30 which corresponds to the second plane 12, by the processing at Step S14. At Step S15, it is checked whether the processing of Steps S10 to S14 is completed for all the picture elements. If a picture element, for which the processing is not performed, exists, the process returns to Step 10, and the processing from Step 10 to Step S14 are repeated until the processing is completed for all the picture elements.

If it is confirmed that the processing is completed to all the picture elements at Step S15, setting of the second plane 12 ends (Step S16A). The above Steps S03 to S16A are performed by the processing section 31b in the graphics engine 31.

The BG data 11a corresponding to the first plane 11, the Video data 12a corresponding to the second plane 12, and the MG data 13a corresponding to the third plane 13 are stored in the memory regions in the image memory 30, respectively.

Subsequently, composite image data is obtained by blending the BG data 11a, the Video data 12a and the MG data 13a by the blend circuit 34. (Step S16).

An image 20 of the obtained composite image data is displayed on the image display panel 10, as shown in FIG. 1 (Step S17).

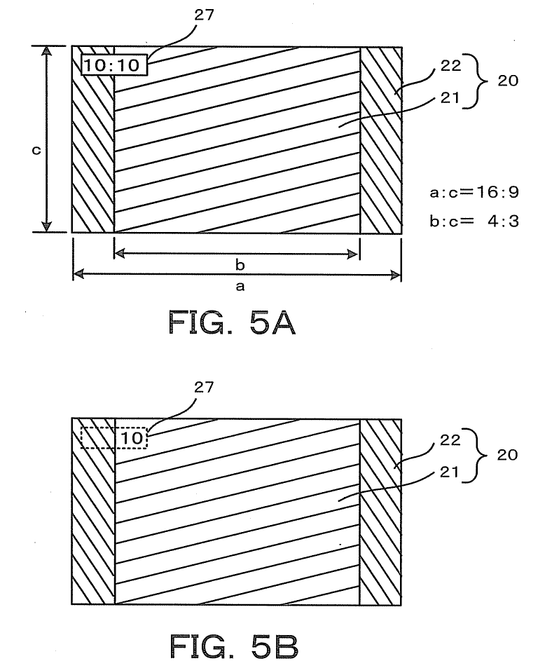

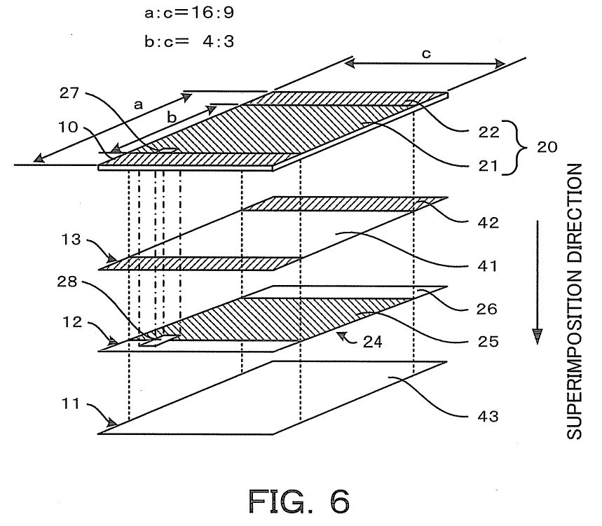

FIG. 5A is a view showing an example of an image displayed on the image display panel 10 by the image processing device according to the embodiment. FIG. 5B is a view showing an image displayed on an image display panel by an image processing device according to a comparative example. FIG. 6 is a view to explain a principle of image display applied to the image processing device according to the comparative example.

As shown in FIG. 6, in the comparative example, a first plane 11 is a BG plane. A second plane 12 is a Video plane. A third plane 13 is an MG plane. The first plane 11 is set to a transparent mode. Accordingly, a fourth image 43 set on the first plane 11 is transparent.

A first image 21 is set on a first region 25 of the second plane 12, which corresponds to the display region of the first image 21. A second regions 26 of the second plane 12, which corresponds to non-display regions of the first image 21, are set to a transparent mode.

In the third plane 13, a first region 41 corresponding to the display region of the first image 21 is set to a transparent mode. Furthermore, second regions 42 of the third plane 13 corresponding to the non-display regions of the first image 21 are filled with a color such as a gray color other than black.

As shown in FIG. 5B, in a display image 20 according to the comparative example, second images 22, which serve as side panels located on both sides of the first image 21, are displayed. A portion of the third image 27 to be displayed so as to overlap one of the second regions 26 is hidden by the third plane 13 and is invisible. The third image 27 may be time information as character information and is set on a third region 28 overlapping the first region 25 and one of the second regions 26.

As shown in FIG. 5A, the second images 22, which serve as side panels, are displayed on both sides of the first image 21, in the display image 20 according to the embodiment. In the embodiment, as shown in FIG. 1, the third plane 13 is set to a transparent mode. Accordingly, the third image 27 set on the third region 28 overlapping the first region 25 and one of the second region 26 is not hidden by the third plane 13, and is displayed, as shown in FIG. 5A.

As described above, with the image processing device according to the embodiment, picture elements that constitute side panels can be made to emit light in a color such as a gray color other than black. Accordingly, uneven brightness deterioration of the display image panel 10 can be prevented.

Furthermore, with the image processing device, the third image 27, displayed in the third region 28 overlapping the first region 25 and one of the second regions 26 adjacent to the first region 2, may be displayed without being hidden by the side panels.

According to the embodiment, the side panels in a color other than black are added to both right and left sides of the first image 21 as the second images 22. Instead, the side panels in a color other than black may be added to the top and bottom sides of the first image 21.

According to the embodiment, the first region 23 is set to a transparent mode in the first plane 11. When a portion of the first region 25 is not set to a transparent mode or semitransparent mode in the second plane 12, an image having a color other than black may be set on the first region 23 of the first plane 11. In the first region 23 of the first plane 11, a region corresponding to the image 21 may be transparent.

According to the embodiment, three planes including a BG plane, a Video plane, and an MG plane are used. Instead, a plurality of BG planes, Video planes, or MG planes may be used. In the embodiment, two side panels are employed. One piece of side panel or a plurality of side panels may be used.

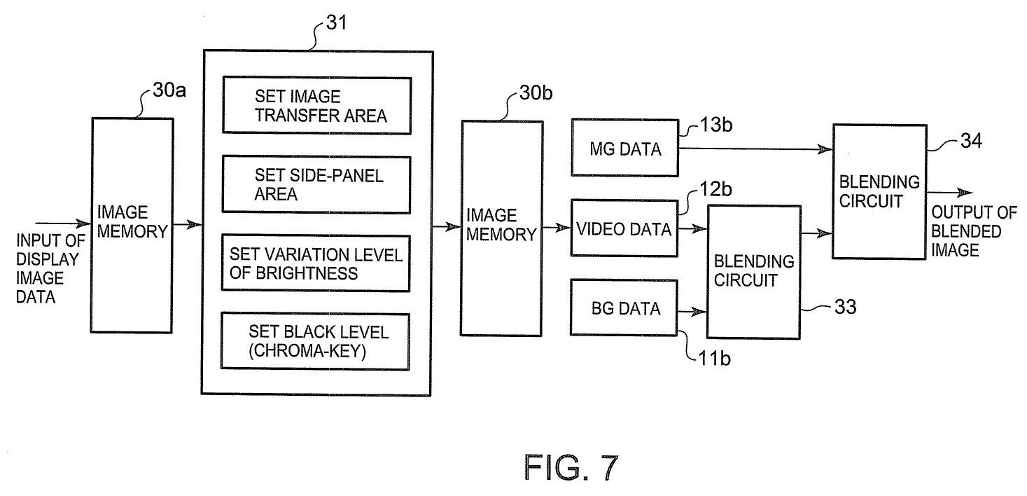

FIG. 7 is a block diagram showing an image processing device according to a modification of the embodiment.

In the modification, image memories 30a, 30b are employed, in place of the image memory 30 used in the above embodiment. The image memory 30a stores data of an inputted display image. The image memory 30b stores image data, which is obtained by processing the stored display image data by the graphics engine 31 in the similar manner as in the above embodiment.

Image data 11b, 12b, 13b, which correspond to the first to the third planes 11 to 13 and which are stored in the image memory 30b, are BG data, Video data, and MG data respectively. The image data 11b, 12b, 13b are blended by the blend circuits 33, 34. In this manner, a composite image data is outputted from the blend circuits 34 to display image on an image display panel 10.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. An image processing device, comprising:
an image memory to receive and store display image data;
a graphics engine to process the display image data stored in the image memory, the graphics engine including first and second processing sections to perform processing of creating image data of first and second planes based on the display image data and to store the created image data in the image memory; and
a blend circuit to blend the stored image data of the first and second planes so that an image of the image data of the second plane can be superimposed on an image of the image data of the first plane, and to output the blended image data to display an image on an image display panel of a self-luminous display, wherein
when the display image data has data of a first image having an aspect ratio different from that of the image display panel, and has data of a second image to be displayed in a non-display region where the first image is not displayed in the image display panel,
the first processing section performs processing to set at least a portion of the image data of the first plane to have a color other than black, the portion corresponding to at least a display region of the second image, and
the second processing section performs processing to set the data of the first image for a first region of the image data of the second plane corresponding to a display region of the first image and to set data of a second region of the second plane corresponding to the non-display region of the first image to a transparent mode, when the data of the second image is black.

2. The image processing device according to claim 1, wherein the blend circuit blends image data of a third plane with the image data of the first and second planes so that an image of the image data of the third plane can be superimposed on the images of the image data of the first and the second planes, and to output the blended image data.

3. The image processing device according to claim 2, wherein the image data of the first to the third planes are BG data, Video data, and MG data, respectively.

4. The image processing device according to claim 2, wherein at least a portion of the image data of the third plane is set to a transparent mode.

5. The image processing device according to claim 1, wherein the non-display region of the first image is determined in accordance with the aspect ratio of the image display panel and the aspect ratio of the first image.

6. The image processing device according to claim 1, wherein
the display image data further includes data of a third image in the non-display region of the first image, and
the data of the third image is set in a portion of the image data of the second plane corresponding to a third region of the third image.

7. The image processing device according to claim 1, wherein
the first processing section of the graphics engine includes a first determination unit,
the first determination unit makes a determination as to whether the data of the second image is black, and
the first determination unit makes the determination by obtaining brightness information of picture elements for the non-display region of the first image, by calculating a ratio of picture elements having the brightness information smaller than a first reference value to all the picture elements, and by determining whether the ratio is not less than a second reference value.

8. The image processing device according to claim 1, wherein
the first processing section in the graphics engine includes a first determination unit to determine whether the data of the second image is black, and
when the first determination unit determines that the data of the second image is not black, the display image data stored in the image memory is outputted to the image display panel of the self-luminous display.

9. The image processing device according to claim 8, wherein
the second processing section of the graphics engine includes a second determination unit,
the second determination unit determines whether picture element data read from the image memory is data of a side panel region, and
when the picture element data is not the data of the side panel region, the second determination unit writes the picture element data in the image memory as the image data of the second plane without any change.

10. The image processing device according to claim 9, wherein
the second processing section of the graphics engine includes a third determination unit,
when the read picture element data is the data of the side panel region, the third determination unit determines whether the read picture element data satisfies a predetermined judgment condition, and
when the read picture element data does not satisfy the predetermined judgment condition, the third determination unit writes the read picture element data in the image memory as picture element data of the second plane without any change.

11. The image processing device according to claim 10, wherein
the second processing section of the graphics engine includes a chroma key processing unit, and
when the read picture element data satisfies the predetermined judgment condition, the chroma key processing unit performs chroma key processing on the picture element data, and writes the processed picture element data in the image memory.

12. The image processing device according to claim 11, wherein
the second processing section in the graphics engine includes a fourth determination unit,
the fourth determination unit determines whether picture element data yet to be read from the image memory is present,
when the picture element data yet to be read is present, the fourth determination unit reads the picture element data and provides the read picture element data to the second determination unit, and
when all the picture element data is read, the fourth determination unit provides the image data of the first and second planes stored in the image memory to the blend circuit.

13. The image processing device according to claim 12, wherein
the display image data further includes data of a third image in the non-display region of the first image, and
the data of the third image is set in a portion of the image data of the second plane corresponding to a third region of the third image.

14. An image processing circuit comprising first and second processing sections, the image processing circuit functioning as a graphics engine to process display image data and to output the processed image data, the image processing circuit creating image data of first and second planes based on the display image data, wherein
when the display image data has data of a first image having an aspect ratio different from that of an image display panel, and has data of a second image to be displayed in a non-display region where the first image is not displayed in the image display panel,
the first processing section sets at least a portion of the image data of the first plane to have a color other than black, the portion corresponding to at least a display region of the second image, and
the second processing section performs processing to set the data of the first image for a first region of the image data of the second plane corresponding to a display region of the first image and to set data of a second region of the second plane corresponding to the non-display region of the first image to a transparent mode, when the data of the second image is black.

15. The image processing circuit according to claim 14, wherein
the first processing section includes a first determination unit to determine whether the data of the second image is black, and
when the first determination unit determines that the data of the second image is not black, the display image data stored in the image memory is outputted to the image display panel of the self-luminous display.

16. The image processing circuit according to claim 15, wherein
the second processing section includes a second determination unit,
the second determination unit determines whether picture element data read from the image memory is data of a side panel region, and
when the picture element data is not the data of the side panel region, the second determination unit writes the picture element data in the image memory as the image data of the second plane without any change.

17. The image processing circuit according to claim 16, wherein
the second processing section includes a third determination unit,
when the read picture element data is the data of the side panel region, the third determination unit determines whether the read picture element data satisfies a predetermined judgment condition, and
when the read picture element data does not satisfy the predetermined judgment condition, the third determination unit writes the read picture element data in the image memory as picture element data of
the second plane without any change.
the second processing section includes a third determination unit, when the picture element data is data of the side panel region, the third determination unit determines whether the read picture element data satisfies a predetermined judgment condition, and
when the picture element data does not satisfy the predetermined judgment condition, the third determination unit writes the picture element data in the image memory as picture element data of the second plane without any change.

18. The image processing circuit according to claim 17, wherein
the second processing section includes a chroma key processing unit, and
when the read picture element data satisfies the predetermined judgment condition, the chroma key processing unit performs chroma key processing on the picture element data, and writes the processed picture element data in the image memory.
the second processing section includes a chroma key processing unit, and
when the picture element data satisfies the predetermined judgment condition, the chroma key processing unit performs chroma key processing on the picture element data, and writes the processed picture element data in the image memory.

19. The image processing circuit according to claim 18, wherein
the second processing section includes a fourth determination unit,
the fourth determination unit determines whether picture element data yet to be read from the image memory is present,
when the picture element data yet to be read is present, the fourth determination unit reads the picture element data and provides the read picture element data to the second determination unit, and
when all the picture element data is read, the fourth determination unit provides the image data of the first and second planes stored in the image memory to the blend circuit.

20. The image processing circuit according to claim 15, wherein
the determination on whether the data of the second image is black is made by the first determination unit by obtaining brightness information of picture elements for the non-display region of the first image, by calculating a ratio of picture elements having the brightness information smaller than a first reference value to all the picture elements, and by determining whether the ratio is not less than a second reference value.
